(19) United States
(12) Patent Application Publication
(10) Pub. No.: US 2020/0034517 A1
(43) Pub. Date: Jan. 30, 2020

(54) INFORMATION PROCESSING APPARATUS, LICENSE MANAGEMENT SYSTEM, AND NON-TRANSITORY RECORDING MEDIUM

(71) Applicant: Masato NAKAJIMA, Kanagawa (JP)

(72) Inventor: Masato NAKAJIMA, Kanagawa (JP)

(21) Appl. No.: 16/383,128

(22) Filed: Apr. 12, 2019

(30) Foreign Application Priority Data
Jul. 30, 2018 (JP) 2018-142998

(51) Int. Cl. G06F 21/12

(52) U.S. Cl. CPC G06F 21/12; G06F 2221/0704

(57) ABSTRACT

An information processing apparatus is in communication with electronic devices via a network to manage a license of a program used in the electronic devices. The information processing apparatus includes circuitry that collects usage information indicating a usage status of each of the electronic devices. The circuitry displays a screen that selectably displays a list of the electronic devices including the collected usage information on a terminal device in communication with the information processing apparatus. The circuitry assigns the license to an electronic device selected from the list of the electronic devices.

### CROSS-REFERENCE TO RELATED APPLICATIONS

This patent application is based on and claims priority pursuant to 35 U.S.C. § 119(a) to Japanese Patent Application No. 2018-142998, filed on Jul. 30, 2018, in the Japan Patent Office, the entire contents of which are hereby incorporated herein by reference.

### BACKGROUND

### Technical Field

The present disclosure relates to an information processing apparatus, a license management system, and a non-transitory recording medium.

### Description of the Related Art

In recent years, due to advances in technologies such as cloud computing, various kinds of applications have been provided as cloud services to electronic devices such as Multifunction Peripheral (MFP). For example, an application that stores image files scanned by the MFP in external storage, an application that prints electronic files downloaded from external storage with the MFP, and the like are provided as a cloud service. Such applications can be used, for example, by assigning a license for using the application to each device.

### SUMMARY

An information processing apparatus is in communication with electronic devices via a network to manage a license of a program used in the electronic devices. The information processing apparatus includes circuitry usage information indicating a usage status of each of the electronic devices. The circuitry displays a screen that selectably displays a list of the electronic devices including the collected usage information on a terminal device in communication with the information processing apparatus. The circuitry assigns the license to an electronic device selected from the list of the electronic devices.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 illustrates an example of a configuration of a license management system according to an exemplary embodiment;

FIG. 2 illustrates an example of a license assignment screen according to an exemplary embodiment;

FIG. 3 illustrates an example of a hardware block diagram of a computer according to an exemplary embodiment;

FIG. 4 illustrates an example of a hardware block diagram of an electric device according to an exemplary embodiment;

FIG. 5 illustrates an example of a functional block diagram of a license management system according to an exemplary embodiment;

FIG. 6A illustrates an example of the first information managed by a cloud server according to an exemplary embodiment;

FIG. 6B illustrates another example of the first information managed by a cloud server according to an exemplary embodiment;

FIG. 6C illustrates a further example of the first information managed by a cloud server according to an exemplary embodiment;

FIG. 7A illustrates an example of the second information managed by a cloud server according to an exemplary embodiment;

FIG. 7B illustrates another example of the second information managed by a cloud server according to an exemplary embodiment;

FIG. 7C illustrates a further example of the second information managed by a cloud server according to an exemplary embodiment;

FIG. 8A illustrates an example of the third information managed by a cloud server according to an exemplary embodiment;

FIG. 8B illustrates another example of the third information managed by a cloud server according to an exemplary embodiment;

FIG. 9A illustrates an example of the fourth information managed by a cloud server according to an exemplary embodiment;

FIG. 9B illustrates another example of the fourth information managed by a cloud server according to exemplary embodiments;

FIG. 10 illustrates an example of a sequence diagram for collection process of usage information according to the first exemplary embodiment;

FIG. 11 illustrates an example of a sequence diagram for display process of license assignment screen according to the first exemplary embodiment;

FIG. 12 illustrates an example of a license assignment screen according to the first exemplary embodiment;

FIG. 13 illustrates an example of a sequence diagram for license assignment process according to the first exemplary embodiment;

FIG. 14 illustrates an example of an application information according to the second exemplary embodiment; and

FIG. 15 illustrates an example of a sequence diagram for display process of license assignment screen according to the second exemplary embodiment.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing the exemplary embodiments only and is not intended to be limiting of the present disclosure. As used herein, the singular forms “a”, “an” and “the” are intended to include the plural forms as well, unless the context clearly indicates otherwise.

In describing the exemplary embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

In the following, exemplary embodiment of the present disclosure is described with reference to the accompanying drawings.

<A Configuration of a License Management System 100>

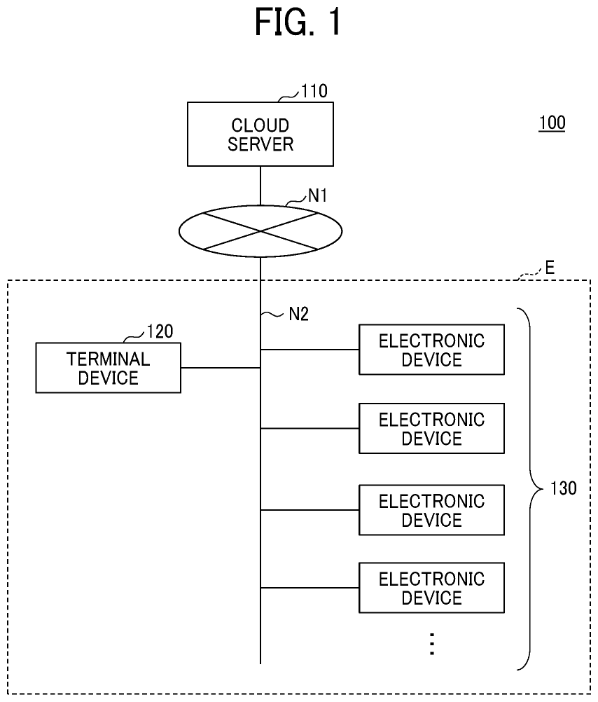

FIG. 1 illustrates an example of a configuration of a license management system 100 according to an exemplary embodiment. As shown in FIG. 1, the license management system 100 according to the exemplary embodiment includes a cloud server 110, a terminal device 120, and one or more electronic devices 130. The terminal device 120 and the one or more electronic devices 130 are in a system environment E of a user who uses the electronic device 130. For example, the terminal device 120 and the one or more electronic devices 130 are communicably connected via a network N2 such as a Local Area Network (LAN). Further, the cloud server 110 and the system environment E are communicably connected via a network N1 such as the Internet. It should be noted that the network N1 and the network N2 may be either wired or wireless, and wired and wireless may be mixed.

The cloud server (information processing device) 110 provides a cloud type application to the electronic device 130 via the network N1. Further, the cloud server 110 is an information processing apparatus (computer) that manages licenses of applications. In the following description, a cloud type application is also referred to as “cloud application” or simply “application”.

The “cloud application” or “application” is an example of a program used in the electronic device 130. The cloud server 110 is an example of an information processing apparatus that manages a license of a program used in the electronic device 130.

An example of the cloud application is an application for storing image data generated by scanning with the electronic device 130 such as a multifunction peripheral in an external storage, an application for printing the electronic file acquired from the external storage by the electronic device 130, and the like.

It should be noted that although the application provided by the cloud server 110 according to this exemplary embodiment is described as a cloud type application, the application is not limited thereto. The application provided by the cloud server 110 may be, for example, a web application or an application provided by an Application Service Provider (ASP).

The terminal device 120 is an information terminal such as a Personal Computer (PC), a smartphone, a tablet terminal or the like used by an administrator or other user of the system environment E, for example. The terminal device 120 is an example of a terminal capable of communicating with the information processing device (the cloud server 110).

The electronic device 130 is, for example, an image forming apparatus such as a Multifunction Peripheral (MFP) having a scan function, a copy function, a print function, a facsimile function, and the like. By using the application provided from the cloud server 110, the electronic device 130 can provide various services to the user. It is to be noted that the license of the application is assigned to the electronic device 130, so that the application can be used.

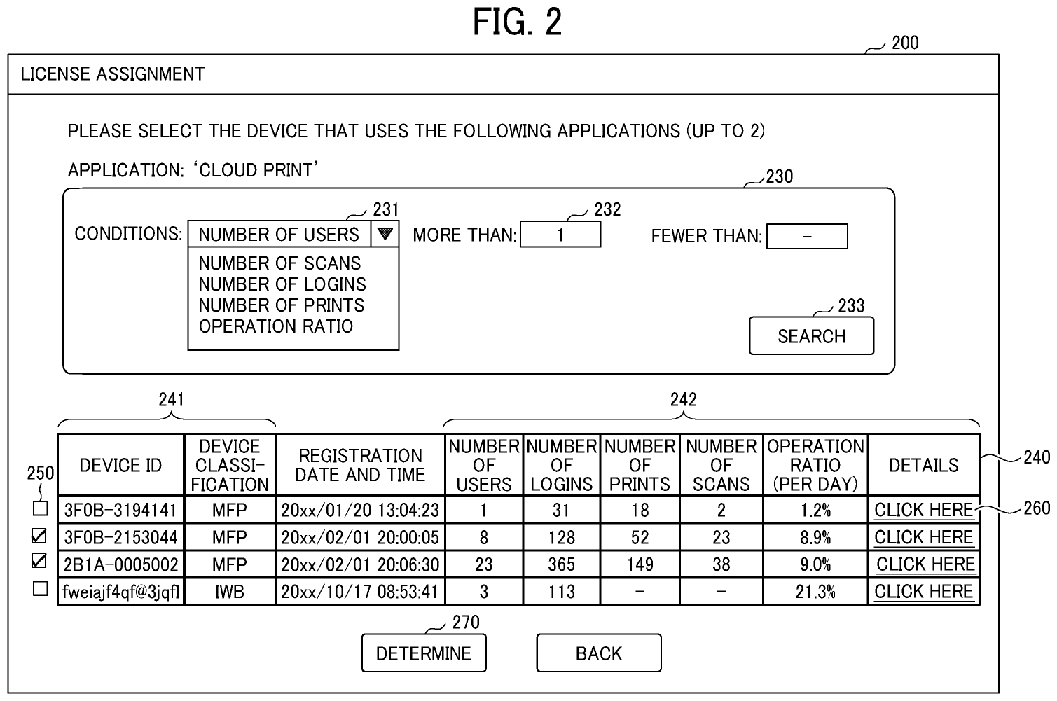

In the above configuration, for example, an administrator or other user managing the system environment E accesses the cloud server 110, by using a web browser provided in the terminal device 120. Then, in the web browser of the terminal device 120, a license assignment screen 200 as shown in FIG. 2 can be displayed.

In the example of FIG. 2, information indicating the number 210 of available licenses, application name 220, a setting area of search condition (setting area) 230, an electronic device list 240, a check box 250 for accepting the selection of the electronic device and the like are displayed on the license assignment screen 200.

The administrator specifies search conditions using the pull-down menu 231 and the input field 232 in the setting area of search condition 230. By selecting the “search” button 233, the administrator can narrow down the electronic devices 130 to be displayed on the electronic device list 240.

The electronic device list 240 includes usage information 242 indicating a usage status of each of the electronic devices 130 such as, information 241 of the electronic device 130 such as a device ID and a device type, a number of users, a number of logins, as number of print, a number of scan, an operation rate, and the like.

The administrator refers to this usage information 242 and decides the electronic device 130 to which the license is assigned. The administrator selects the check box 250 corresponding to the determined electronic device 130 and selects the “determine” button 270. As a result, a license for using the application is assigned to the selected electronic device 130.

For example, in the license management system 100 as shown in FIG. 1, the number of licenses of applications that can be used by the plurality of electronic devices 130 may be limited. In such a case, it is difficult for the administrator to decide the electronic device 130 to which the license is assigned unless there is information for determining which electronic device 130 the license is to be assigned.

Therefore, for example, in some techniques, the administrator prepares beforehand such as checking the usage status of each electronic device 130 in advance before assigning a license.

On the other hand, in the license management system 100 according to this exemplary embodiment, as shown in FIG. 2, the electronic device list 240 including usage information 242 indicating the usage status of each electronic device 130 is displayed on the license assignment screen 200. Using the usage information 242, the administrator can easily decide the electronic device 130 to which the license is to be assigned, by an arbitrary method such as “Assign licenses to electronic devices with a large (more) number of users” or “Assign licenses to electronic devices with a large (more) number of prints”, for example.

Further, the administrator can narrow down the electronic devices 130 displayed in the electronic device list 240 by using the setting area 230. Therefore, even when the number of the electronic devices 130 is large, the administrator can easily decide the electronic device 130 to which the license is assigned.

As described above, according to this embodiment, in the license management system 100 that manages licenses that can be used by the plurality of electronic devices 130, the manager and user can easily decide the electronic device 130 to which the license is assigned from the plurality of electronic devices 130.

Note that the configuration of the license management system 100 shown in FIG. 1 is merely an example, and other configurations may be adopted. For example, the cloud server 110 may be an information processing system (computer system) composed of a plurality of information processing devices.

Also, the system environment E may include a plurality of terminal devices 120. Further, the electronic device 130 is not limited to a multifunction peripheral, but may be a digital camera, a printing device, a copier, a projector, a facsimile, an electronic conference terminal, an electronic blackboard device, an audio device, an onboard device (for example, a car navigation system), home appliances (for example, a refrigerator) and the like.

Furthermore, the administrator may operate the license assignment screen 200 as shown in FIG. 2, not only by using the web browser of the terminal device 120 but also by using the web browser of the electronic device 130. The electronic device 130 including the web browser is another example of a terminal device capable of communicating with the information processing device (the cloud server 110).

<A Hardware Block Diagram>

(A Hardware Block Diagram of Cloud Server and Terminal Device)

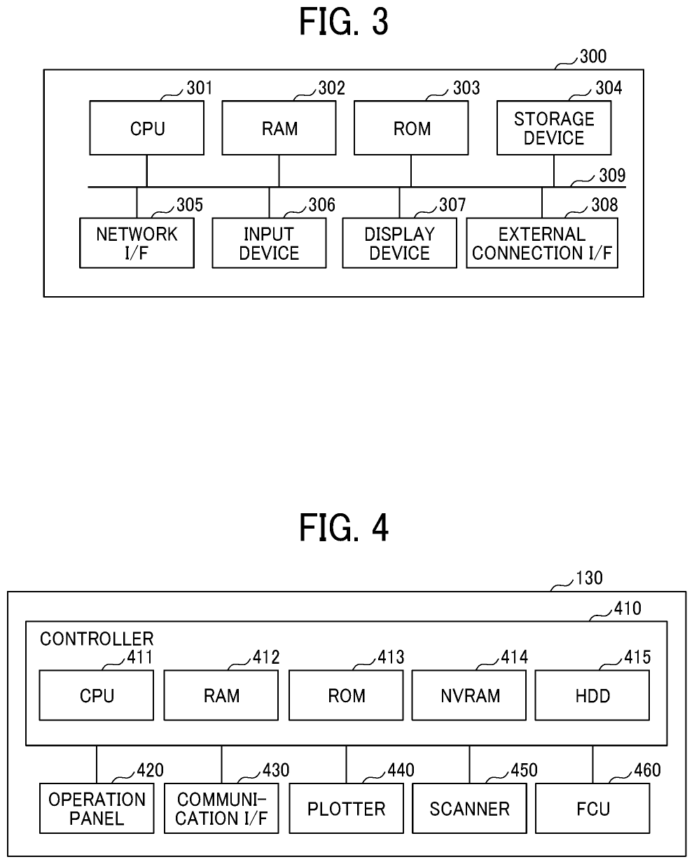

One or more information processing devices that realize the cloud server 110 and the terminal device 120 are realized by a computer 300 shown in FIG. 3, for example.

FIG. 3 illustrates an example of a hardware block diagram of the computer 300 according to an embodiment. The computer 300 includes circuitry such as, for example, a Central Processing Unit (CPU) 301, a Random Access Memory (RAM) 302, a Read Only Memory (ROM) 303, a storage device 304, a network Interface (I/F) 305, an input device 306, a display device 307, an external connection interface (I/F) 308, a bus 309, and the like.

The CPU 301 is an arithmetic device that implements each function of the computer 300 by reading out programs and data stored in the ROM 303, the storage device 304, and the like onto the RAM 302 and executing processing. The RAM 302 is a volatile memory used as a work area and the like of the CPU 301. The ROM 303 is a nonvolatile memory that holds programs and data even when the power is turned off.

The storage device 304 is a large-capacity storage device such as a Hard Disk Drive (HDD), a Solid State Drive (SSD), and stores an Operating System (OS), an application, various data, for example. The network I/F 305 is a communication interface for connecting the computer 300 to the networks N1, N2 and the like.

The input device 306 is, for example, a pointing device such as a mouse or an input device such as a keyboard. The input device 306 is used to input each operation signal to the computer 300. The display device 307 is a display device such as a display, and displays processing results and the like by the computer 300. Note that the input device 306 and the display device 307 may be display input devices such as a touch panel display, for example.

The external connection I/F 308 is an interface for connecting an external device to the computer 300. The external device includes, for example, various storage media. The bus 309 is connected to each of the above components and transmits an address signal, a data signal, various control signals, and the like.

(A Hardware Block Diagram of Electronic Device)

FIG. 4 illustrates an example of a hardware block diagram of the electric device according to an exemplary embodiment. Note that the electronic device 130 may be various devices typically having a computer configuration. In this embodiment, as an example, a hardware configuration in a case where the electronic device 130 is an image forming device will be described.

The electronic device 130 includes circuitry such as, for example, a controller 410, an operation panel 420, a communication I/F 430, a plotter 440, a scanner 450, a fax control unit (hereinafter referred to as FCU).

The controller 410 has a computer configuration, and includes, for example, a CPU 411, a RAM 412, a ROM 413, a nonvolatile RAM (NVRAM) 414, a HDD 415, and the like.

The ROM 413 is a nonvolatile storage device that stores various programs and data. The RAM 412 is a volatile storage device that temporarily holds programs and data. The NVRAM 414 is a writable nonvolatile storage device for storing, for example, setting information and the like. The HDD 415 is a large-capacity storage device that stores various programs and data.

The CPU 411 is an arithmetic device that controls the whole of the electronic device 130 and realizes each function by reading a program, data, setting information, and the like from the ROM 413, the NVRAM 414, the HDD 415 and the like onto the RAM 412 and executing processing.

The operation panel 420 includes an input unit that accepts input from the user and a display unit that performs display. The communication I/F 430 is a communication interface for connecting the electronic device 130 to the networks N1, N2 and the like.

The plotter 440 is a printing apparatus that prints print data. The scanner 450 is a reading device that reads a document and the like. The FCU 460 transmits and receives fax data and the like.

<A Functional Block Diagram>

Hereinafter, a description is given of a functional configuration of the license management system 100 according to the exemplary embodiment.

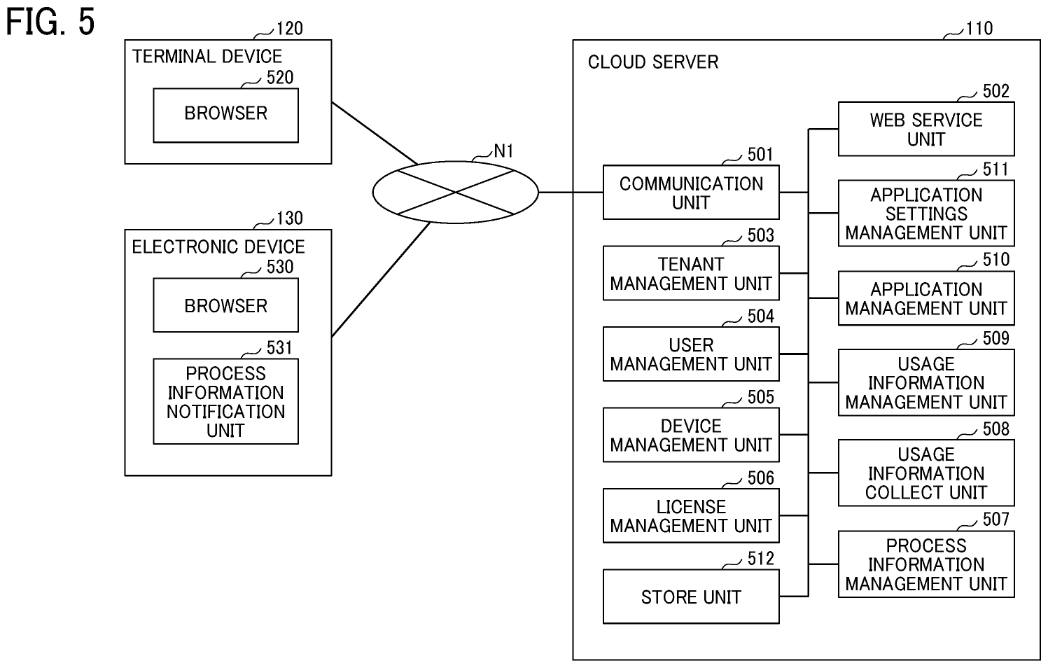

FIG. 5 illustrates an example of the functional block diagram of the license management system according to an embodiment.

The cloud server 110, the terminal device 120, and the electronic device 130 shown in FIG. 5 correspond to the cloud server 110, the terminal device 120, and the electronic device 130 shown in FIG. 1, respectively. It is sufficient that the terminal device 120 and the electronic device 130 can communicate with the cloud server 110 via the network N1. In the following description, it is assumed that the terminal device 120 and the electronic device 130 are connected to the network N1 as shown in FIG. 5.

(A Functional Block Diagram of Terminal Device)

The terminal device 120 has a general-purpose web browser 520 (hereinafter referred to as “browser 520”).

The user (for example, the administrator of the system environment E) of the terminal device 120 can display the license assignment screen as shown in FIG. 2, for example, by using the browser 520, and can assign the license of the application.

(A Functional Block Diagram of Electronic Device)

The electronic device 130 includes a general-purpose web browser 530 (hereinafter referred to as “browser 530”) and the process information notification unit 531. A user of the electronic device 130 can use the application provided by the cloud server 110 using the browser 310.

The process information notification unit 531 is realized, for example, by a program executed by the CPU 411 in FIG. 4 and sends information of processing (e.g., printing, scanning, logging in, logging out, etc.) executed by the electronic device 130 to the cloud server 110. The information of processing includes, for example, a device ID for identifying the electronic device 130, a user ID for identifying a user who uses the electronic device 130, an execution date and time, and various information on the executed processing (for example, a classification (type) of processing, a process number of sheets, color / monochrome, execution result, etc.).

Note that the electronic device 130 further has one or more functional configurations for realizing the functions (for example, image forming functions, etc.) of the electronic device 130, but the description thereof will be omitted here for the sake of brevity.

(A Functional Block Diagram of Cloud Server)

The cloud server 110 includes, for example, a communication unit 501, a web service unit 502, a tenant management unit 503, a user management unit 504, a device management unit 505, a license management unit 506, a process information management unit 507, a usage information collect unit 508, a usage information management unit 509, an application management unit 510, an application setting management unit 511, and the like.

The cloud server 110 implements each of the above-described functional configurations by executing a predetermined program (license management program) in, for example, the CPU 301 or the plurality of computers 300 in FIG. 3. At least a part of each of the above functional configurations may be realized by hardware.

The communication unit 501 connects the cloud server 110 to the network N1 and communicates with the terminal device 120, the electronic device 130, and the like, for example, using the network I/F 305 in FIG. 3.

The web service unit (display control unit) 502 provides a web page displaying the license assignment screen 200 as shown in FIG. 2 to the browser 520 or the like of the terminal device 120 capable of communicating with the cloud server 110. Note that the web service unit 502 is an example of a display control unit for displaying a license assignment screen 200 for selectably displaying the electronic device list 240 including usage information 242 on the terminal device 120 capable of communicating with the cloud server 110.

The tenant management unit 503 stores and manages information of a tenant (hereinafter referred to as tenant information) which is a contract unit contracting a license of an application in the store unit 512 or the like. Note that the tenant may include various contracting units such as a company, a business division, a department, a section, an official, a team, a floor, and the like.

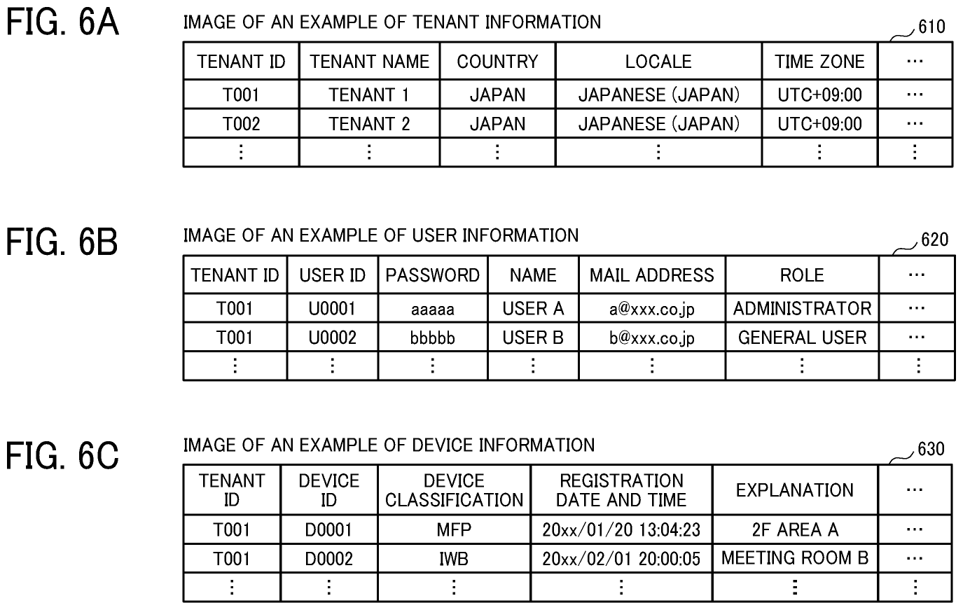

FIG. 6A illustrates an example of the image of the tenant information 610 stored in the store unit 512 by the tenant management unit 503. In the example of FIG. 6A, the tenant information 610 includes information such as “tenant ID”, “tenant name”, “country”, “locale”, “time zone”, and the like as items.

The “tenant ID” is identification information for identifying a tenant. The “tenant name” is information indicating the name of a tenant and the like. The “country” is information indicating a country to which a tenant belongs or the like. The “locale” is, for example, information indicating a language, a unit of country and region, a format of a symbol, a date, and a currency, etc. corresponding to a tenant, “Time zone” is information indicating a time zone to which the tenant belongs.

Information other than “tenant ID” among the above information is optional and may not be included in the tenant information 610.

The user management unit 504 stores and manages information of a user registered in the license management system 100 (hereinafter referred to as user information) in the store unit 512 or the like.

FIG. 6B illustrates an example of the image of the user information 620 stored in the store unit 512 by the user management unit 504. In the example of FIG. 6B the user information 620 includes information such as “tenant ID”, “user ID”, “password”, “name”, “mail address”, “role”, and the like as items. In addition, the user information 620 may further include information such as “locale”, “time zone”, and the like.

The “tenant ID” is identification information for identifying a tenant to which a user belongs, and corresponds to, for example, the tenant ID included in the tenant information 610 shown in FIG. 6A. The “user ID” is identification information for identifying a user. The “password” is an example of authentication information for a user to log in to the license management system 100. The “name” is information indicating the name of the user and the like.

The “mail address” is information indicating the user's mail address and the like. The “role” is information indicating the authority of the user. The authority of the user includes, for example, the authority of the administrator and the authority of the general user who does not have the authority of the administrator. Information such as “name”, “locale”, “time zone”, etc. are optional, and may not be included in the user information 620. The “mail address” can also be used as a login ID for logging in the license management system 100.

The user management unit 504 authenticates the user who requests login to the license management system 100. The user management unit 504 issues a user authentication ticket which is authentication information for using the license management system 100 to the terminal device 120 used by the user who succeeds in authentication. For example, when a combination of the user ID and the password included in the login request is registered in the user information 620, the user management unit 504 permits login by the user.

The device management unit 505 stores and manages information (hereinafter referred to as device information) of the electronic device 130 (device) registered in the license management system 100 in the store unit 512 or the like.

FIG. 6C illustrates an example of the image of the device information 630 stored in the store unit 512 by the device management unit 505. In the example of FIG. 6C, the device information 630 includes information such as “tenant ID”, “device ID”, “device classification”, “registration date and time”, “explanation”, and the like as items.

The “tenant ID” is identification information for identifying a tenant to which the electronic device 130 belongs, and corresponds to, for example, a tenant ID included in the tenant information 610 in FIG. 6A. The “device ID” is identification information for identifying the electronic device 130. The “device classification” is information indicating the type of the electronic device 130 such as MFP, Interactive White Board (IWB), or the like, for example.

The “registration date and time” is information indicating the date and time when the electronic device 130 is registered in the license management system 100. The “explanation” is supplementary information on the electronic device 130, for example, electronic device information such as the location where the electronic device 130 is installed (set). The information of “registration date and time” and “explanation” is optional and may not be included in the device information 630.

The license management unit 506 stores and manages license information which is information of the application license managed by the license management system 100, device license assignment information, user license assignment information and the like in the store unit 512 or the like. The license management unit 506 may manage license information on a package basis including a plurality of applications. Further, the application and the package are examples of programs for which the license management system 100 manages licenses.

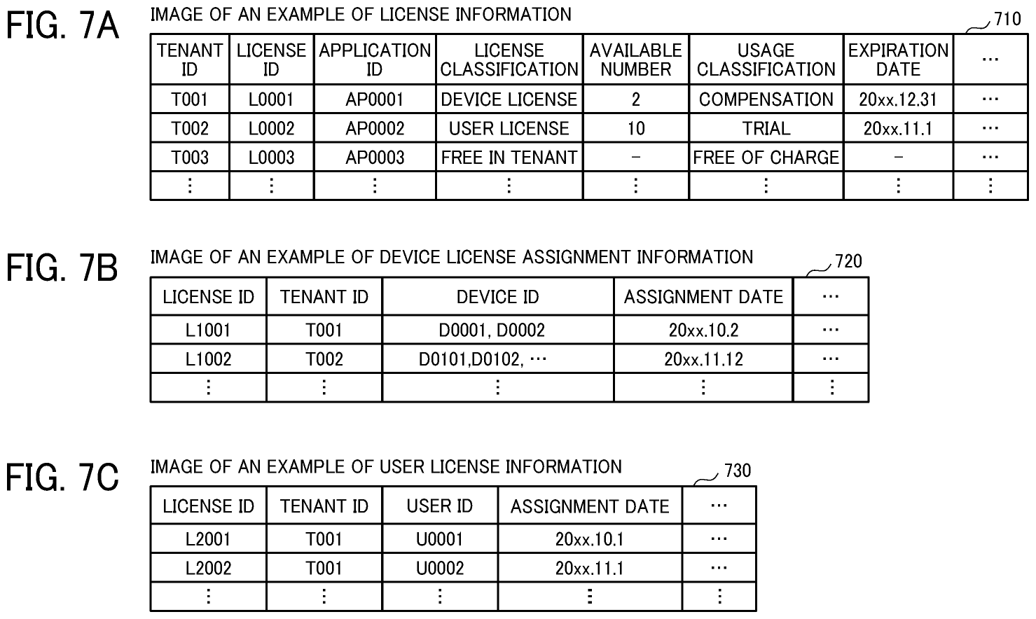

FIG. 7A illustrates an example of the image of the license information 710 stored in the store unit 512 by the license management unit 506. In the example of FIG. 7A, the license information 710 includes information such as “tenant ID”, “license ID”, “application ID”, “license classification”, “available number”, “usage classification” and “expiration date”, and the like as items.

The “tenant ID” is identification information for identifying a tenant having a license and corresponds to, for example, the tenant ID included in the tenant information 610 in FIG. 6A. The “license ID” is identification information for identifying a license. The “application ID” is identification information for identifying the application corresponding to the license ID. The “license classification” is, for example, information indicating a classification (type) of license such as a device license, a user license, or free within tenant.

The “available number” is information indicating the number of electronic devices 130 or users permitted to use the license. For example, in FIG. 7A, the license with the license ID “L0001” has a license classification (type) of “device license” and the available number is “2”. Therefore, the application with the application ID “AP0001” can be used by the two electronic devices 130.

The “usage classification” is, for example, information indicating the classification (type) of compensation (charge), trial, free of charge (gratuitous) etc. The “expiration date” is information indicating the term of validity of the license in the case of a license with a term.

FIG. 7B illustrates an example of the image of the device license assignment information 720 stored in the store unit 512 by the license management unit 506. In the example of FIG. 7B, the device license assignment information 720 includes information such as “license ID”, “tenant ID”, “device ID”, “assignment date”, and the like as items.

The “license ID” is identification information for identifying the license of the application and corresponds to the license ID included in the license information 710 in FIG. 7 A. The “tenant ID” is identification information for identifying a tenant that contracts a license corresponding to the license ID, and corresponds to, for example, the tenant ID included in the license information 710 in FIG. 7A. The “device ID” is identification information for identifying the electronic device 130 to which the license corresponding to the license ID is assigned.

For example, the license management unit 506 stores and manages the device ID of the electronic device 130 selected on the license assignment screen 200 as shown in FIG. 2 in the “device ID” of the device license assignment information 720. The “assignment date” is information indicating the date on which “device ID” was registered or updated.

The license management unit 506 manages the electronic device 130 to which the license of the application is assigned by using the device license assignment information 720.

FIG. 7C illustrates an example of the image of the user license assignment information 730 stored in the store unit 512 by the license management unit 506. In the example of FIG. 7C, the user license assignment information 730 includes information such as “license ID”, “tenant ID”, “user ID”, “assignment date”, and the like as items.

The “license ID” is identification information for identifying a license assigned to a user. The “tenant ID” is identification information for identifying a tenant that contracts a license corresponding to a license ID. The “user ID” is identification information for identifying a user to whom a license corresponding to a license ID is assigned. The “assignment date” is information indicating the date on which “user ID” was registered or updated.

The license management unit 506 manages the user to whom the application license is assigned by using the user license assignment information 730.

Returning to FIG. 5, the description of the functional configuration of the cloud server 110 is continued.

The process information management unit 507 stores and manages information of processing executed by one or more electronic devices 130 included in the license management system 100 in the store unit 512 or the like. For example, the process information management unit 507 receives information on processing transmitted from each electronic device 130 and manages by adding a process ID to the information on the received processing.

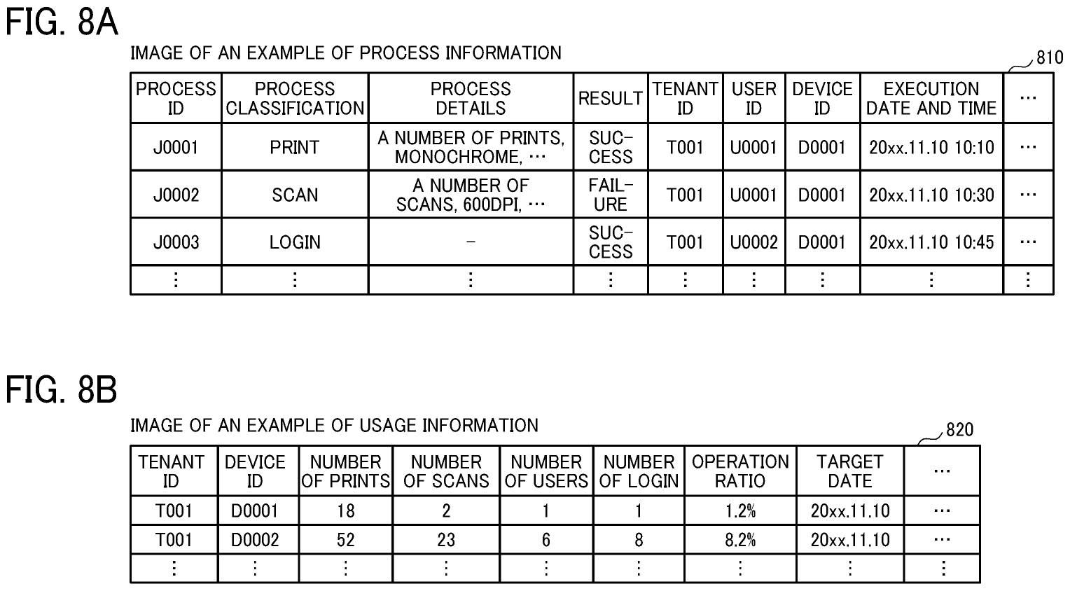

FIG. 8A illustrates an example of the process information 810 stored in the store unit 512 by the process information management unit 507. In the example of FIG. 8A, the process information 810 includes “process ID”, “processing classification”, “process details”, “result”, “tenant ID”, “user ID”, “device ID”, and “execution date and time”, and the like.

The “process ID” is identification information for identifying a process, and is added, for example, when the process information management unit 507 stores process information in the process information 810.

The “process classification” is information indicating the classification (type) of processing such as printing, scanning, logging, and the like, for example. The “process detail” is information indicating specific processing contents such as the number of prints, the number of scanned sheets, color/monochrome, resolution, and the like. The “result” is information indicating processing results such as success/failure, for example.

The “tenant ID”, “user ID”, and “device ID” are identification information for identifying the tenant, the user, and the device that executed the process. The “execution date and time” is information indicating the date and time when the process was executed.

The usage information collection unit 508 collects the process information 810 managed by the process information management unit 507, and creates usage information indicating the usage status of each electronic device 130. For example, the usage information collection unit 508 collects information such as the number of prints, the number of scans, the number of users, the number of logins, the operation ratio, and the like in each electronic device 130 as batch processing once a day, and creates the usage information. The number of prints, the number of scans, and the number of logins are examples of information on the number of usage (times of use) of the electronic device 130.

The usage information management unit 509 stores and manages the usage information created by the usage information collection unit 508 in the store unit 512.

FIG. 8B illustrates an example of the usage information 820 stored in the store unit 512 by the usage information management unit 509. In the example of FIG. 8B, the usage information 820 includes “tenant ID”, “device ID”, “number of prints”, “number of scans”, “number of users”, “number of logins”, “operation ratio”, “target date”, and the like as items.

The “tenant ID” and “Device ID” are identification information for identifying the tenant corresponding to each use information and the electronic device 130. The “number of prints” is information indicating the number of prints (for example, a number of times of printing, a number of sheets to be printed, and the like) executed on “target date” in each electronic device 130. The “number of scans” is information indicating the number of scans (for example, a number of times of reading, a number of sheets to be read, etc.) executed on “target date” in each electronic device 130. The “number of users” is information indicating the number of users who used each electronic device.

The “number of logins” is information indicating the number of login processes executed in “target date” in each electronic device 130. The “operation ratio” is information that occupies the ratio of the operation time to the total operation time. The “target date” is information indicating the creation date of usage information. The item of usage information 820 shown in FIG. 8B is an example of the case where the electronic apparatus 130 is an image forming apparatus, and the usage information 820 includes various kinds of information indicating usage status of the electronic apparatus 130.

The application management unit 510 stores and manages information of an application (hereinafter referred to as application information) whose license is managed by the cloud server 110 in the store unit 512.

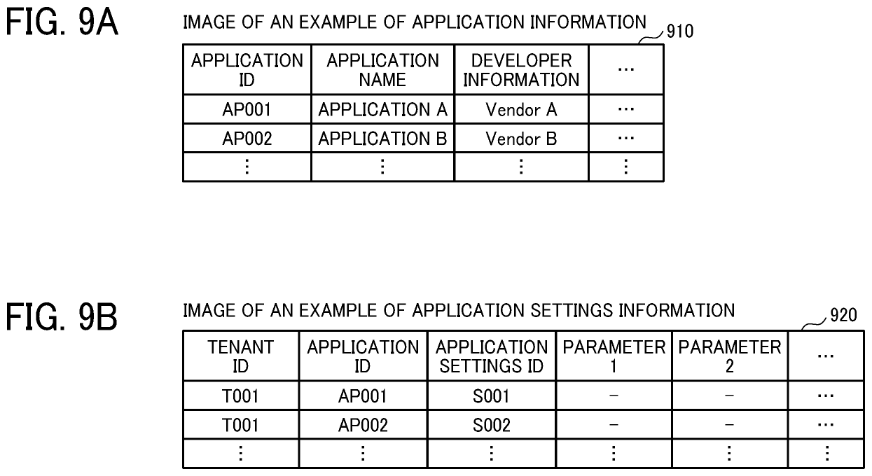

FIG. 9A illustrates an example of the application information 910 stored in the store unit 512 by the application management unit 510. In the example of FIG. 9A, the application information 910 includes information such as “application ID”, “application name”, and “developer information” as items.

The “application ID” is identification information for identifying an application, and corresponds to, for example, an application ID included in license information 710 in FIG. 7 A. The “application name” is information indicating a name of the application. The “developer information” is information indicating a developer of the application or a supplier of the application.

The application setting management unit 511 stores and manages the application setting information storing the setting of the application in the store unit 512.

FIG. 9B illustrates an example of the application setting information 920 stored in the store unit 512 by the application setting management unit 511. In the example of FIG. 9B, the application setting information 920 includes information such as “tenant ID”, “application ID”, “application setting ID”, “parameter 1”, “parameter 2”, and the like as items.

The “tenant ID” is identification information for identifying a tenant that contracts a license of an application, and corresponds to, for example, a tenant ID included in the tenant information 610 in FIG. 6A. The “application ID” is identification information for identifying an application, and corresponds to, for example, an application ID included in the application information 910 in FIG. 9A. The “application setting ID” is identification information for identifying the setting of the application. In “parameter 1” and “parameter 2”, setting parameters unique to each application are stored.

The store unit 512 is realized by, for example, a program executed by the CPU 301 in FIG. 3, the storage device 304, the RAM 302, and the like, and stores various information including each information described in FIGS. 6 to 9. Note that the store unit 512 may be realized by an external storage server, a database server, or the like.

<The Flow of Process>

Subsequently, the flow of the process of the license management method according to the exemplary embodiment are described.

[First Exemplary Embodiment]

(Collection Process of Usage Information)

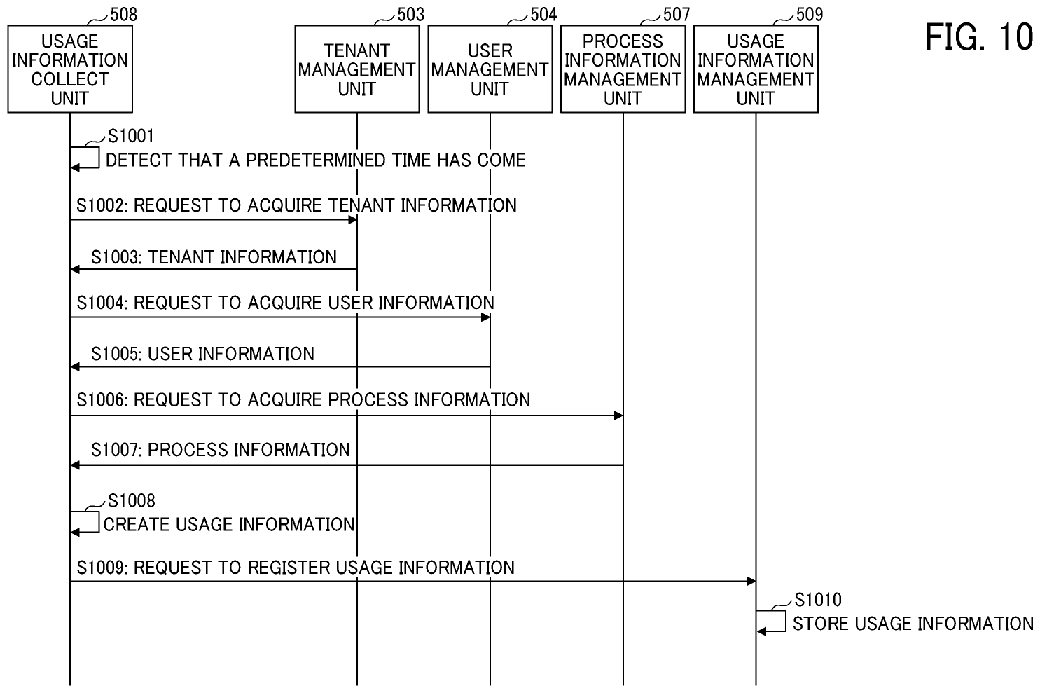

FIG. 10 illustrates an example of a sequence diagram for collection process of usage information according to the first exemplary embodiment. As an example, this process is executed by the cloud server 110 as batch processing every predetermined period (for example, every day).

At the start of the process shown in FIG. 10, the information such as the tenant information 610, the user information 620, the license information 710, the application information 910, the application setting information 920 and the like described above is preset by the administrator or the like. Further, it is assumed that the process information management unit 507 of the cloud server 110 stores the process information transmitted from each electronic device 130, for example, in the process information 810 shown in FIG. 8A.

In step S1001, when the usage information collect unit 508 of the cloud server 110 detects that the predetermined time has come, the process in step S1002 and subsequent steps is executed.

In steps S1002 and S1003, the usage information collect unit 508 acquires the tenant information 610 managed by the tenant management unit 503. Note that the usage information collect unit 508 may read the tenant information 610 from the store unit 512 without going through the tenant management unit 503.

Preferably, the usage information collect unit 508 executes the following process for each tenant based on the acquired tenant information.

In steps S1004 and S1005, the usage information collect unit 508 acquires the user information 620 managed by the user management unit 504. Note that the usage information collect unit 508 may read the user information 620 from the store unit 512 without going through the user management unit 504.

In steps S1006 and S1007, the usage information collect unit 508 acquires the processing information 810 managed by the processing information management unit 507. For example, from the processing information 810 shown in FIG. 8A, the usage information collect unit 508 acquires the process information of “execution date and time” corresponding to a period to be processed (for example, 24 hours of the previous day). Note that the usage information collect unit 508 may read the process information 810 from the store unit 512 without going through the process information management unit 507.

In step S1008, the usage information collect unit 508 counts (tabulates) the acquired process information, and creates usage information 820 as shown in FIG. 8B, for example.

For example, the usage information collect unit 508 specifies the user ID of the user belonging to the tenant of the tenant ID “T001” by using the acquired tenant information 610 and user information 620.

Further, the usage information collect unit 508 extracts the process ID of the process including the tenant ID “T001” from the process information 810 as shown in FIG. 8A, and calculates the number of prints, the number of scans, the number of users, the number of logins, operation ratio, and the like for each device ID.

For example, the “number of prints” of the electronic device 130 with the device ID “D0001” can be calculated by counting the number of process information that the process classification (type) is “print” out of the process information that has the extracted processing ID and device ID “D0001”. This also applies to the number of scans and the number of logins.

The “number of users” of the electronic device 130 with the device ID “D0001” can be calculated by counting the number of different user IDs included in the process information having the extracted processing ID and the device ID “D0001”.

The operation ratio of the electronic device 130 with the device ID “D0001” can be calculated from the ratio between the total time each user has logged in the electronic device 130 and the operation time of the electronic device 130. The total time that each user has logged in the electronic device 130 can be calculated using the extracted processing ID and the processing information having the device ID “D0001”.

The usage information collect unit 508 can create usage information as shown in each line of the usage information 820 in FIG. 8B, for example, by using the above process for each device ID.

In step S1009, the usage information collect unit 508 requests registration of the created usage information to the usage information management unit 509. In step S1010, the usage information management unit 509 transmits and stores the requested usage information to the store unit 512.

By the above processing, the usage information 820 as shown in FIG. 8B is created every predetermined period (for example, every day) and stored in the store unit 512.

(Display Process of License Assignment Screen)

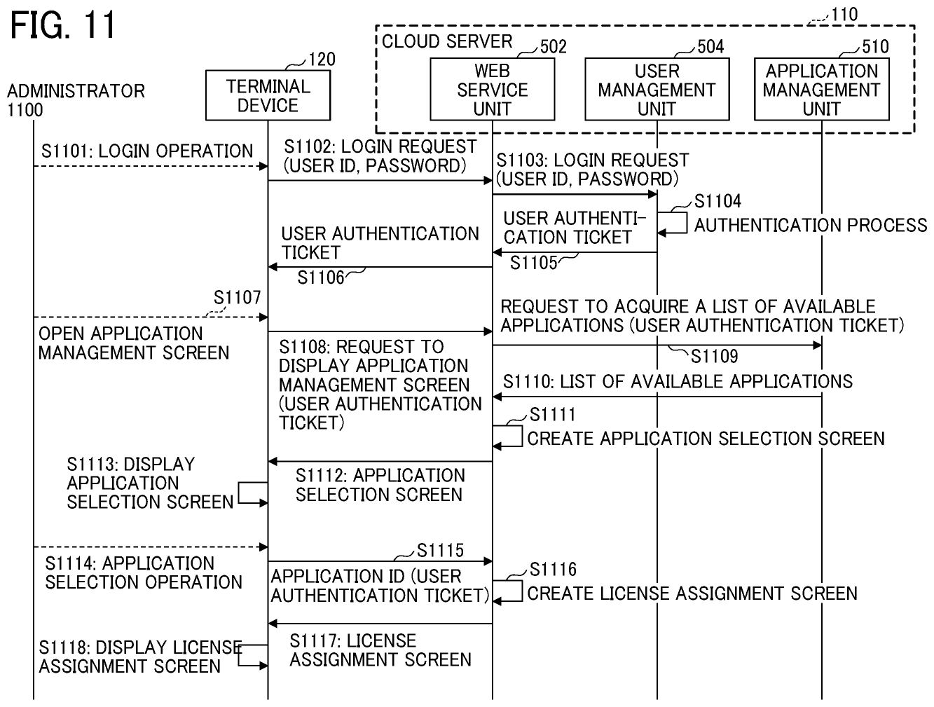

FIG. 11 illustrates an example of a sequence diagram for display process of license assignment screen according to the first exemplary embodiment. This process illustrates an example of a process executed when the administrator 1100 of the system environment E displays the license assignment screen 200 as shown in FIG. 2 using the browser 520 of the terminal device 120.

In step S1101, the browser 520 of the terminal device 120 receives a login operation by the administrator 1100. For example, the administrator 1100 uses the browser 520 to access a web page provided by the web service unit 502 of the cloud server 110, and inputs a user ID and a password. In addition, the browser 520 accepts the user ID, password, and the like input by the administrator 1100.

In step S1102, the browser 520 of the terminal device 120 transmits a login request including the accepted user ID, password, and the like to the web service unit 502 of the cloud server 110.

In step S1103, upon receiving the login request, the web service unit 502 of the cloud server 110 notifies the user management unit 504 of the received login request or the user ID and password included in the login request.

In step S1104, the user management unit 504 of the cloud server 110 performs authentication process on the user ID and password notified from the Web service unit 502. For example, when a combination of the notified user ID and password is stored in the user information 620 as shown in FIG. 6B, the user management unit 504 permits the user's login. On the other hand, if the combination of the notified user ID and password is not stored in the user information 620 as shown in FIG. 6B, the user management unit 504 rejects the user's login. When the user's login is permitted, the processing from step S1105 onward is executed.

In steps S1105 and S1106, the user management unit 504 issues a user authentication ticket for using the service provided by the cloud server 110, and notifies the browser 520 of the terminal device 120 via the Web service unit 502.

In step S1107, it is assumed that the browser 520 of the terminal device 120 receives an operation of opening an application management screen for managing the application by the administrator 1100.

In step S1108, the browser 520 of the terminal device 120 transmits a display request of the application management screen including the user authentication ticket to the Web service unit 502 of the cloud server 110, in response to the operation by the administrator 1100.

In step S1109, upon receiving the request to display the application management screen, the Web service unit 502 of the cloud server 110 requests the application management unit 510 to acquire a list of applications (available applications) that can be used by the administrator 1100.

In step S1110, the application management unit 510 of the cloud server 110 notifies the Web service unit 502 of the list of applications registered in the application information 910, for example, as shown in FIG. 9A.

In steps S1111 and S1112, the Web service unit 502 of the cloud server 110 creates a selection screen of an application for selectably displaying a list of available applications, and transmits the screen to the browser 520 of the terminal device 120.

In step S1113, the browser 520 of the terminal device 120 displays the application selection screen received from the Web service unit 502 of the cloud server 110.

In step S1114, the browser 520 of the terminal device 120 receives an application selection operation by the administrator 1100.

In step S1115, the browser 520 of the terminal device 120 transmits the application ID of the selected application to the Web service unit 502 of the cloud server 110, together with the user authentication ticket, in response to the application selection operation by the administrator 1100.

In steps S1116 and S1117, the Web service unit 502 of the cloud server 110 creates a license assignment screen of the application corresponding to the application ID received from the browser 520 of the terminal device 120, and transmits the license assignment screen to the browser 520 of the terminal device 120.

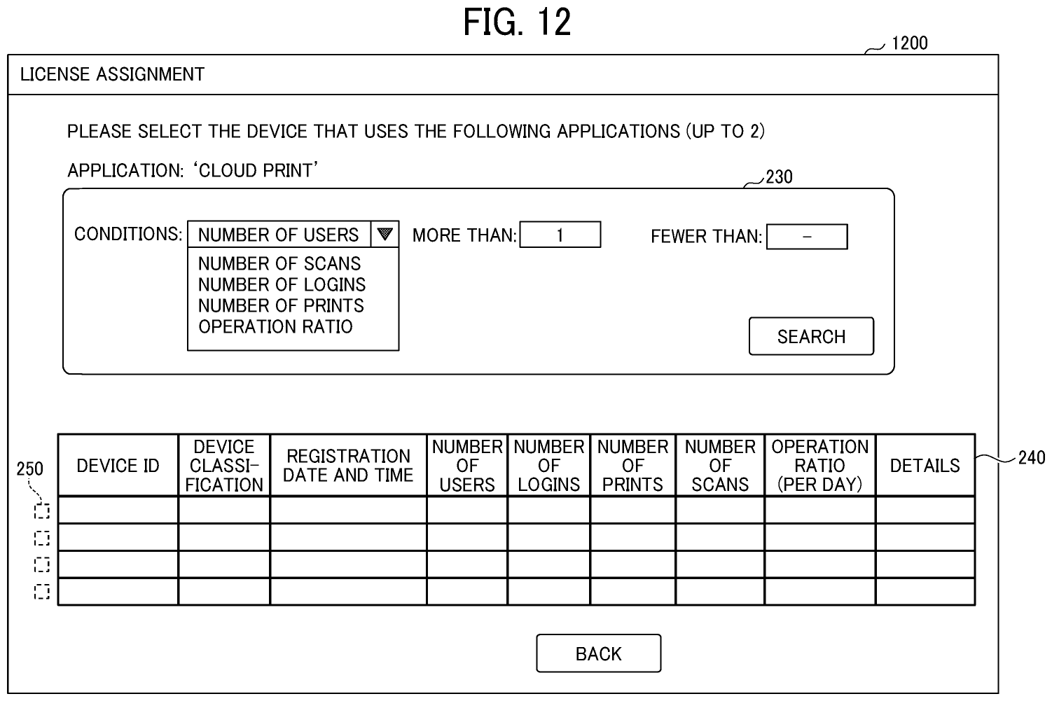

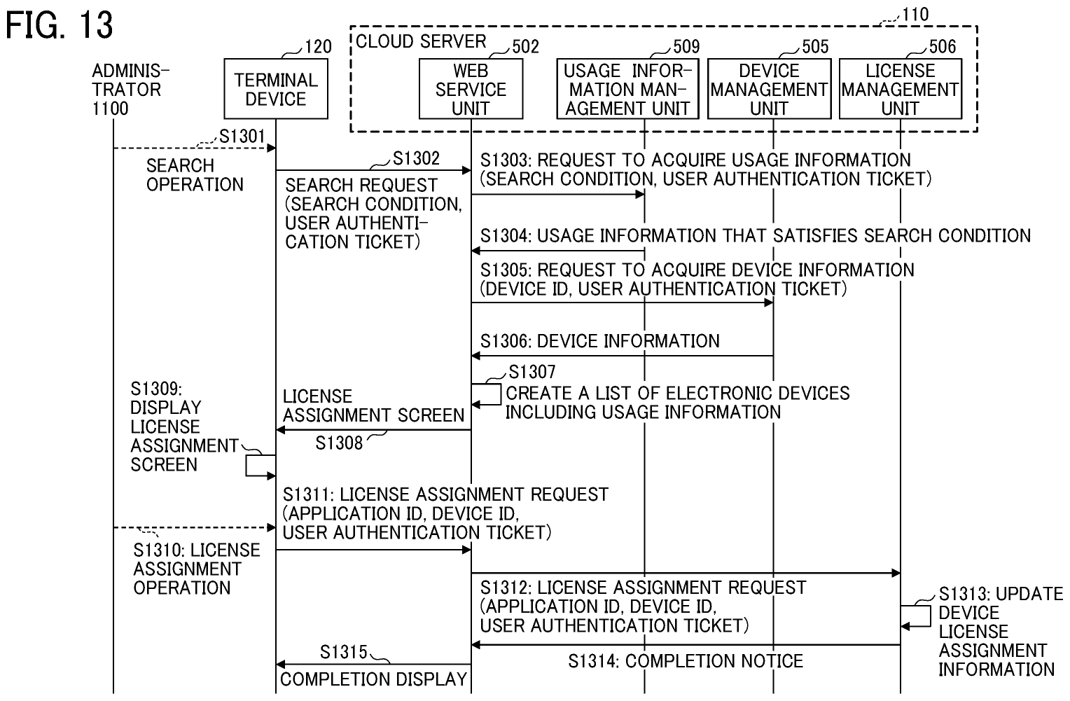

In step S1118, the browser 520 of the terminal device 120 displays, for example, a license assignment screen 1200 as illustrated in FIG. 12.

FIG. 12 illustrates an example of a license assignment screen according to the first exemplary embodiment. As shown in FIG. 12, at this point of time, no information may be displayed in the electronic device list 240 of the license assignment screen 1200. At this time, it is preferable that the check box 250 for accepting the selection of the electronic device is inactivated so as not to be selectable.

As another example, in the electronic device list 240 of the license assignment screen 1200, the information of the electronic device 130 searched under the default search condition may be displayed.

(License Assignment Process)

FIG. 13 illustrates an example of a sequence diagram for license assignment process according to the first exemplary embodiment. This process illustrates an example of processing executed when the administrator 1100 assigns the license of the application to the electronic device 130 using the license assignment screen 1200 shown in FIG. 12.

In step S1301, the browser 520 of the terminal device 120 receives a search operation by the administrator 1100 or the like. For example, the administrator 1100 sets a search condition in the setting area 230 on the license assignment screen 1200 as shown in FIG. 12, and the browser 520 accepts the set search condition.

For example, as shown in the setting area 230 of FIG. 12, the search condition may include one or more conditions in the usage information 820 such as “the number of users”, “the number of scans”, “the number of logins”, “the number of prints”, “operation ratio” and the like.

In step S1312, the browser 520 of the terminal device 120 transmits a search request including the accepted search condition and the user authentication ticket to the Web service unit 502 of the cloud server 110.

In steps S1303 and S1304, the Web service unit 502 of the cloud server 110 acquires usage information satisfying the search condition from the usage information 820 managed by the usage information management unit 509.

For example, it is assumed that the administrator belongs to the tenant of the tenant ID “T001”, and the search conditions are “the number of users” and “more than 1”. In this case, the usage information management unit 509 extracts usage information whose tenant ID is “T001” and the number of users is “more than 1” from the usage information 820 as shown in FIG. 8B, and notifies the Web service unit 502.

In steps S1305 and S1306, the Web service unit 502 acquires the device information of the electronic device 130 corresponding to the device ID included in the usage information acquired in step S1304 from the device information 630 managed by the device management unit 505.

In step S1307, the Web service unit 502 creates the electronic device list 240 as shown in FIG. 2, for example. For example, the information of “device ID”, “number of users”, “number of logins”, “number of prints”, “number of scans”, and “operation ratio” in the electronic device list 240 are created using usage information acquired in step S1304. Further, the “device classification” and the “registration date and time” in the electronic device list 240 are created using the device information 630 acquired in step S1306.

Preferably, the Web service unit 502 rearranges the information of the plurality of electronic devices 130 retrieved according to the search condition in ascending order or descending order according to the search condition, and creates the electronic device list 240.

For example, when the search condition is the “number of users”, the Web service unit 502 displays the information of the plurality of electronic devices 130 searched according to the search condition in descending order of the number of users on the electronic device list 240. For example, when the search conditions are the “operation ratio” and “fewer than 10%”, the Web service unit 502 displays the information of the plurality of electronic devices 130 searched according to the search condition on the electronic device list 240 in the descending order of the operation ratio. The Web service unit 502 may display it in the ascending order of the operation ratio.

In addition, preferably, the Web service unit 502 creates and displays the electronic device list 240 of the plurality of electronic devices 130 retrieved according to the search condition within the range of a preset display number.

For example, in the case where the display number of the electronic device list 240 is set to “4”, even when there are five or more pieces of information of the plurality of electronic devices 130 searched according to the search condition, as shown in FIG. 2, the information of the four electronic devices 130 is displayed in the electronic device list 240.

Thus, for example, even when the number of electronic devices 130 managed by the license management system 100 is large, the administrator can efficiently determine the electronic device 130 to which the license is assigned.

In step S1308, the Web service unit 502 transmits, for example, a license assignment screen 200 as shown in FIG. 2 including the created electronic device list 240 to the browser 520 of the terminal device 120.

In step S1309, the browser 520 of the terminal device 120 displays the license assignment screen 200 received from the Web service unit 502.

In the license assignment screen 200 shown in FIG. 2, the electronic device list 240 displays the information 241 of the electronic device 130 satisfying the search condition and the usage information 242 indicating the usage situation of each electronic device 130. As a preferable example, the administrator can refer to more detailed usage information of each electronic device 130 by selecting the “click here” link 260 displayed in “details” of the electronic device list 240.

In the license assignment screen 200 shown in FIG. 2, the check box 250 for accepting the selection of the electronic device to which the license is assigned is activated and displayed to be able to accept the selection.

In step S1310, for example, the browser 520 of the terminal device 120 accepts a license assignment operation by the administrator on the license assignment screen 200 as shown in FIG. 2. For example, in the license assignment screen 200 shown in FIG. 2, the administrator refers to the usage information 242 indicating the usage status of each electronic device 130 and selects the check box 250 corresponding to the electronic device 130 to which the license is assigned.

As an example, when the administrator would like to assign a license to the electronic device 130 having a higher operating ratio, the administrator may select the check box 250 corresponding to the electronic device 130 with the device ID “fweiajf4qf@3jqf.” In addition, when the administrator would like to assign a license to the electronic device 130 having a larger number of users, the administrator may select the check box 250 corresponding to the electronic device 130 with the device ID “2B1A-0005002.”

As described above, the license assignment screen 200 according to this embodiment includes the usage information 242 indicating the usage status of each electronic device 130 in the electronic device list 240. So, the administrator can easily select the electronic device 130 to which the license is assigned.

In step S1311, the browser 520 of the terminal device 120 transmits a license assignment request including the application ID of the application, the device ID of the electronic device 130 that received the selection, and the user authentication ticket to the cloud server 110.

In step S 1312, the Web service unit 502 of the cloud server 110 notifies the license management unit 506 of the accepted license assignment request.

In step S1313, the license management unit 506 registers the accepted device ID in the device license assignment information 720 as shown in FIG. 7B, for example.

For example, the license management unit 506 refers to the license information 710 as shown in FIG. 7A and specifies the license ID corresponding to the application ID included in the license assignment request. Further, the license management unit 506 stores the device ID included in the license assignment request in association with the specified license ID in the device license assignment information 720 as shown in FIG. 7B.

In step S1314, the license management unit 506 notifies the Web service unit 502 of a completion notice (notification) indicating that the assignment of the license has been completed.

In step S1315, the Web service unit 502 causes the browser 520 of the terminal device 120 to display a completion indication indicating that the license assignment has been completed.

According to this embodiment, in the license management system 100 that manages licenses that can be used by the plurality of electronic devices 130, the user can easily decide the electronic device to which the license is assigned from among the plurality of electronic devices 130.

[Second Exemplary Embodiment]

In the first exemplary embodiment described above, for example, as shown in FIG. 12, the Web service unit 502 of the cloud server 110 does not display the information of the electronic device 130 to the electronic device list 240 until the search condition is set by the administrator.

However, for example, when an administrator is not familiar with the content of the application, there are cases where the administrator may be confused as to how to set the search condition. Therefore, in the second exemplary embodiment, an example of a case where information of the recommended electronic device 130 is displayed in the electronic device list 240 regardless of the setting of the search condition by the administrator will be described.

<A Functional Block Diagram>

A functional block diagram of the license management system 100 according to the second exemplary embodiment is the same as that of the license management system according to the embodiment shown in FIG. 5.

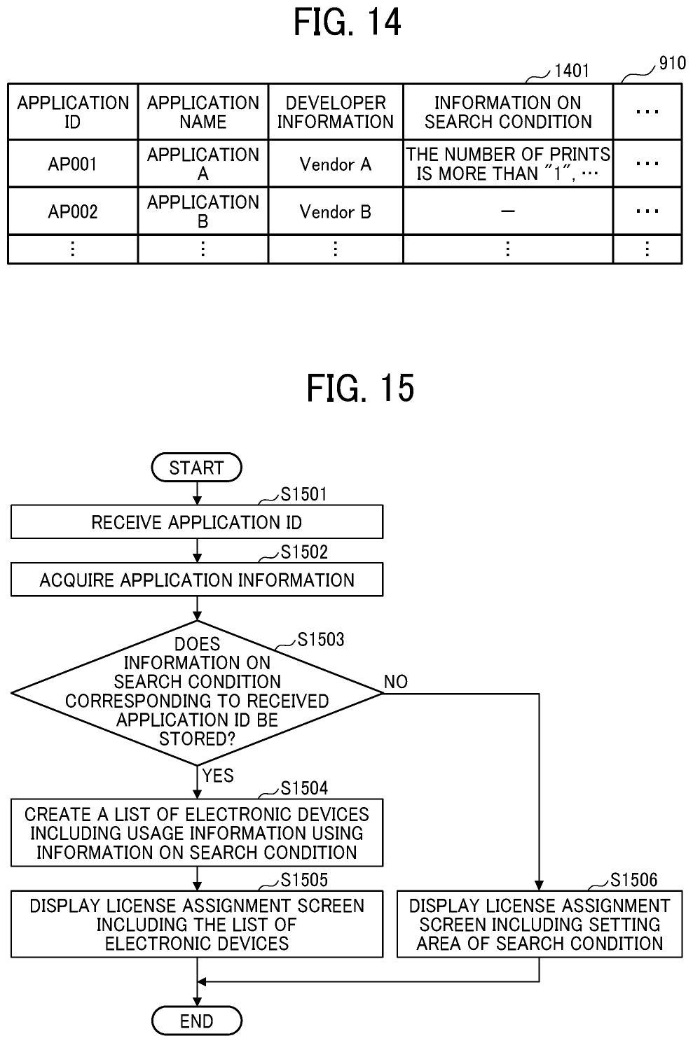

However, the application management unit 510 of the cloud server 110 stores and manages, for example, the application information 910 as shown in FIG. 14 in the store unit 512.

FIG. 14 illustrates an example of the application information according to the second exemplary embodiment. The application information 910 according to the second embodiment shown in FIG. 14 is additionally provided with “information on search conditions” 1401, in addition to items managed by the application information 910 according to the embodiment shown in FIG. 9A.

“Information on search conditions” 1401 is set by, for example, a service provider operating the license management system 100 or a developer who developed the application and the like. Further, the “information on the search condition” 1401 is used as a search condition in steps S1303 to S1304 of FIG. 13. Note that the “information on the search condition” 1401 may be a search condition itself, or identification information corresponding to the search condition or the like.

<The Flow of Process>

FIG. 15 illustrates an example of a sequence diagram for display process of license assignment screen according to the second exemplary embodiment. This process shows another example of the process in which the web service unit 502 displays the license assignment screen on the browser 520 of the terminal device 120 in steps S1115 to S1117 of FIG. 11.

In step S1501, the Web service unit 502 of the cloud server 110 receives the application ID transmitted together with the user authentication ticket from the browser 520 of the terminal device 120. This process corresponds to the process of step S1115 in FIG. 11.

In step S1502, the Web service unit 502 acquires, for example, application information 910 such as that shown in FIG. 14 managed by the application management unit 510.

In step S1503, the Web service unit 502 determines whether or not “information on search conditions” 1401 corresponding to the accepted application ID is stored in the acquired application information 910.

In case that “information on search condition” 1401 corresponding to the received application ID is stored, the Web service unit 502 shifts the process to step S1504. On the other hand, in case that the “information on the search condition” corresponding to the received application ID is not stored, the Web service unit 502 shifts the process to step S1506.

In step S1504, the Web service unit 502 creates the electronic device list 240 including usage information 242 of the electronic device 130, using the “information on search condition” 1401 corresponding to the received application ID.

For example, the Web service unit 502 determines a search condition using “information on search condition” 1401 corresponding to the accepted application ID. Then, the Web service unit 502 executes the processing of steps S1303 to S1307 of FIG. 13 to create the electronic device list 240 including usage information 242.

In step S1505, the Web service unit 502 causes the browser 520 of the terminal device 120 to display a license display screen including the created electronic device list 240.

For example, the Web service unit 502 causes the browser 520 of the terminal device 120 to display the license assignment screen 200 as shown in FIG. 2. As another example, the Web service unit 502 may cause the browser 520 of the terminal device 120 to display a license assignment screen that does not include the setting area 230.

On the other hand, when shifting from step S1503 to step S1506, as in the first embodiment, the Web service unit 502 causes the browser 520 of the terminal device 120 to display a license assignment screen that includes the setting area 230 as shown in FIG. 2.

Through the above processing, the Web service unit 502 can display the information of the recommended electronic device 130 in the electronic device list 240 such as the license assignment screen 200, regardless of the setting of the search condition by the administrator or the like.

The table (corresponding to the table of FIG. 14) for determining which electronic device is recommended may be generated by the learning effect of machine learning.

Here, the machine learning is a technique for causing a computer to acquire learning ability like a person. The machine learning is a technique of autonomously generating algorithms necessary for judgment such as data identification from learning data to be captured in advance and applying this to new data to make prediction.

A learning method for the machine learning may be any one of supervised learning, unsupervised learning, half-teacher learning, reinforcement learning, and depth learning. Furthermore, the learning method for the machine learning may be a learning method combining these learning methods.

As described above, according to each embodiment, in the license management system 100 that manages licenses that can be used by the plurality of electronic devices 130, the user can easily decide the electronic device to which the license is assigned from the plurality of electronic devices 130.

Further, when a replacement of an image forming apparatus is to be performed after starting a license agreement, a renewed license can be issued to a new image forming apparatus replacing the older image forming apparatus.

For example, when the replacement of the image forming apparatus is to be performed, the license can be issued to a new image forming apparatus by selecting the new image forming apparatus and the older image forming apparatus from the list of device serial numbers associated with the issued license.

However, the list of device serial numbers includes only identification information for identifying the image forming apparatus and information such as registration date. For this reason, it is difficult for a user to decide an image forming apparatus to which a license is assigned from among a plurality of image forming apparatuses.

In conventional technologies, it is difficult for a user to decide an image forming apparatus to which a license is assigned in a license management system for managing licenses usable by a plurality of electronic devices.

As to above described embodiment, it is easier for a user to decide an image forming apparatus to which a license is assigned in a license management system for managing licenses usable by a plurality of electronic devices.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

For example, each functional configuration included in the cloud server 110 shown in FIG. 5 may be realized by a program executed by a plurality of information processing apparatuses. In addition, the store unit 512 included in the cloud server 110 may be realized by a storage server or the like outside the system.

The electronic device is not limited on Multifunction Peripheral (MFP). For example, the apparatus capable of executing and displaying the application may be a projector (PJ), Interactive White Board (IWB:A white board having an electronic blackboard function capable of mutual communication), an output device such as a digital signage, a Head Up Display (HUD), an industrial machinery, an imaging device, a sound collector, a medical device, a network home appliance, a personal computer, a mobile phone, a smartphone, a tablet terminal, a game machine, a Personal Digital Assistant (PDA), a digital camera, a wearable PC, a desktop PC or the like.

1. An information processing apparatus in communication with electronic devices via a network to manage a license of a program used in the electronic devices, the information processing apparatus comprising:
circuitry configured to:
collect usage information indicating a usage status of each of the electronic devices;
display a screen that selectably displays a list of the electronic devices including the collected usage information on a terminal device configured to communicate with the information processing apparatus; and
assign the license to an electronic device selected from the list of the electronic devices.

2. The information processing apparatus according to claim 1, wherein
the circuitry displays, on the terminal device, a setting area to receive a search condition of the electronic device to be displayed on the list of the electronic devices on the screen, and
the circuitry determines the electronic device to be displayed on the list of the electronic devices on the screen, based on the search condition set in the setting area.

3. The information processing apparatus according to claim 2, wherein
the circuitry sorts information of the electronic devices searched based on the search condition in ascending order or descending order, and
the circuitry displays, on the terminal device, the information on the list of electronic devices.

4. The information processing apparatus according to claim 2, wherein
the circuitry displays, on the terminal device, information on the electronic device searched based on the search condition on the list of electronic devices within a range of preset display numbers.

5. The information processing apparatus according to claim 1, further comprising:
a memory configured to store, for the each program, information on the search conditions of electronic devices to be displayed on the list of electronic devices,
wherein the circuitry determines the electronic device to be displayed on the list of electronic devices on the screen, based on the information on the search condition of electronic device stored in the memory.

6. The information processing apparatus according to claim 1, wherein
the circuitry acquires and manages processing information for the each electronic device, and
the circuitry collects the usage information indicating the usage status of each of the electronic devices by counting the processing information for the each electronic device.

7. The information processing apparatus according to claim 1, wherein
the circuitry collects the usage information indicating the usage status of each of the electronic devices every predetermined period,
the circuitry manages the usage information indicating the usage status of each of the electronic devices, and
the circuitry displays the screen that selectably displays a list of the electronic devices based on the usage information indicating the usage status of each of the electronic devices.

8. The information processing apparatus according to claim 1, wherein
the usage information includes at least one of number of users, number of usage, and operation ratio of the electronic devices.

9. A license management system in communication with electronic devices via a network to manage a license of a program used in the electronic devices, the license management system comprising:
circuitry configured to;
collect, usage information indicating a usage status of each of the electronic devices;
display a screen that selectably displays a list of the electronic devices including the collected usage information on a terminal device configured to communicate with the license management system; and
assign the license to an electronic device selected from the list of the electronic devices.

10. A non-transitory recording medium storing computer-readable instructions that, when executed by a computer that is in communication with electronic devices via a network and that manages a license of a program used in the electronic devices, cause the computer to perform a method comprising:
collecting usage information indicating a usage status of each of the electronic devices;
displaying a screen that selectably displays a list of the electronic devices including the collected usage information on a terminal device configured to communicate with the computer; and
assigning the license to an electronic device selected from the list of the electronic devices.
